(19) United States
(12) Patent Application Publication
(10) Pub. No.: US 2005/0145667 A1
(43) Pub. Date: Jul. 7, 2005

(54) Novel apparatus for securing decorative staples

(76) Inventor: Yehudah Noam Susson, Riverdale, NY (US)

Correspondence Address: David W. Barman, 1101 NE 176 Terrace, North Miami Beach, FL, 33162, US

(21) Appl. No.: 10/744,314

(22) Filed: Dec. 22, 2003

(51) Int. Cl. B25C 5/06

(52) U.S. Cl. 227/120; 227/134

(57) ABSTRACT

An apparatus for securing ornamental staples is disclosed and described.

### SUMMARY OF THE INVENTION

A novel apparatus for the fastening of decorative staples is disclosed and described.

### BACKGROUND OF THE INVENTION

The modern business office has seen a tremendous advance in products available for use. There is no shortage of conveniences available, both aesthetic and functional. One particular part of the office has remained relatively unchanged. Papers are held together by either a paper clip, binder clip, or staple. The staple is a small piece of metal that, with the aid of a very familiar apparatus called “the stapler” forces the wire through the sheets and is bent in a manner such that the papers are secured together as a bundle. That ever present piece of metal gets noticed all-too-often as an unsightly, but commonly accepted intrusion on neatly bundled and bound pages. There is a need to bind papers with the security of a staple without having an ugly piece of metal on the corner and/or edge of the document.

### SUMMARY OF THE INVENTION

It is an object of the invention to provide a novel apparatus for securing decorative staples to multiple sheets of paper.

It is an object of the invention to provide an ornamental or decorative staple as the securing means for multiple sheets of paper.

It is another object of the invention to secure a decorative staple to multiple sheets of paper by conventional forming means.

It is another object of the invention to provide an apparatus, which can repeatedly deliver decorative staples from a plurality of staples stored within the apparatus.

It is another object of the invention to deliver decorative staples by mechanical or electronic means.

It is another object of the invention to deliver decorative staples which may include logos and industry/sport/interest specific designs as well as monograms and decorative themes etc.

It is another object of the invention to deliver decorative staples which may be used outside of the office environment, including Commercial, hobbyists, students, home users etc.

It is another object of the invention to deliver decorative staples which may be incorporated into many kinds of automated stapling machines e.g., photo copy machines.

### BRIEF DESCRIPTION OF THE DRAWINGS

FIG. 1 shows a decorative staple with a logo on its' upper potion.

FIG. 2 shows the arrangement of decorative staples such that a plurality of staples may be stored inside the apparatus and dispensed at the time of use.

FIG. 3 shows a side view of the apparatus with the area for storing and delivering the decorative staples shown in cut away

FIG. 4 shows a cut away view of the decorative staples storage chamber of the apparatus.

FIG. 5 shows a decorative staples before it is formed as a securing means

FIG. 6 shows a decorative staples after it has been bent to form a securing means

FIGS. 7-12 show various illustrative embodiments illustrating the decorative nature of the staples.

### DETAILED DESCRIPTION OF THE PREFERRED EMBODIMENT

The current invention relates to decorative staples and an apparatus for applying them.

The decorative staple, before use, is comprised of two parallel, vertical members which are each bent and form a horizontal transverse portion. The transverse portion has a surface secured to the transverse portion. The secured surface may contain a monogram, a logo, decorative design and the like. The secured surface will hereinafter be termed the “ornamental surface.” The ornamental surface may be on the same level/height as the top of the staple. In one embodiment, it may be made of the wire itself, or additional wire to create the design (in addition to the ‘plate top’ which may be of any shape, so long as it fits within the maximum dimensions allowed). The ornamental surface may additionally provide a means for advertising a product or merely an ornamental design through printing indicia, engraving, embossing, etching, or by other suitable means by which an image is placed on the ornamental surface. A design, logo, picture, monogram, name or advertising may be displayed on the ornamental surface. The ornamental surface will be substantially planer to the stabled surface. The term “substantially planer” means that it will be elevated above the surface, but its' general orientation will be planer relative to the stabled surface.

The apparatus is used by loading a plurality of staples into the loading chamber. A standard staple has a consistent width. The decorative stable of the present invention has an ornamental surface with a width which is greater than the general width of the other members of the staple. Because this ornamental surface extends past the general width of the members of the staple, the decorative staple of the present invention cannot be used in a conventional stapler. The apparatus is formed of elements to account for the repeated fastening of individual decorative staples. The user will activate the stapler to dispense a single staple and secure it into place by standard forming means. After a decorative staple has been individually dispensed and secured, the apparatus will reset and is ready to dispense another decorative staple.

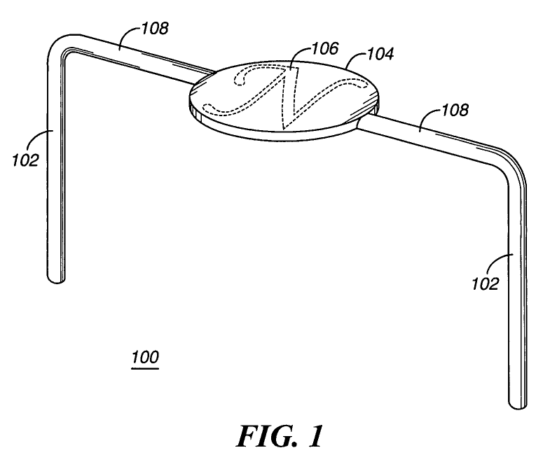

FIG. 1 shows a decorative staple 100 in which two vertical members 102 extend downward from a transverse member 108. Said transverse member 108 has secured to it an ornamental surface 104 The staple top with the design may also be made of the wire itself or additional wire serving as a top for the staple, its height over the paper would be no greater than a standard staple which contains printing indicia, engraving, embossing, etching or other suitable means, which creates a design on the visible surface of the staple.

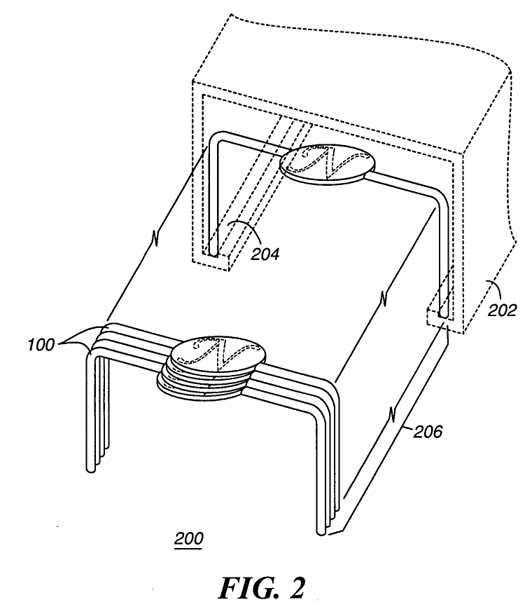

FIG. 2 shows loading chamber 200 being so formed with an outer face 202 and an inner edge 204 which is used for guiding the decorative staple in to place for future use. The individual staples 100 are so formed as to fit into a stackable arrangement wherein they may be singly dispensed for use.

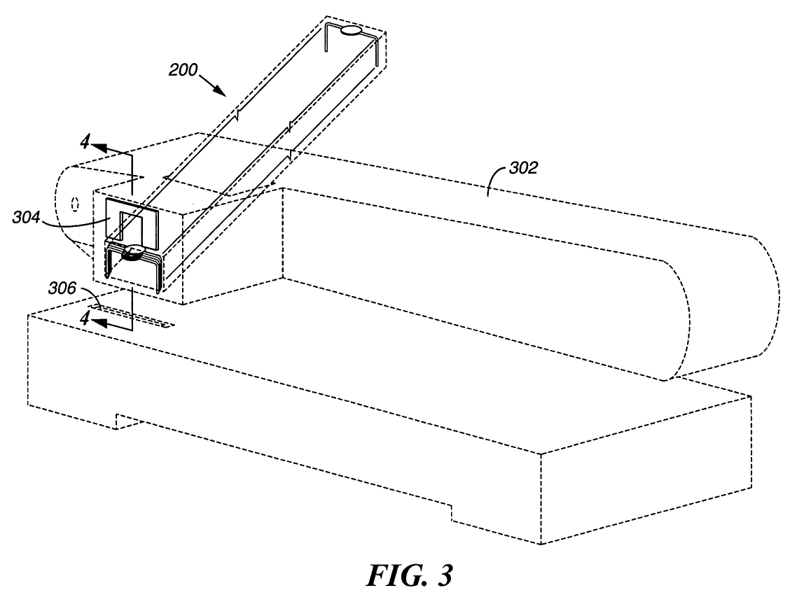

FIG. 3 shows the entire apparatus in which loading chamber 200 is connected to control chamber 302. When control chamber 302 is depressed by the user, discharge plate 304 pushes an individual decorative staple out of the loading chamber 200. The loading chamber is shown in a configuration demonstrating that it is necessary to be on an angle relative to the bottom portion of the apparatus. With each subsequent discharge of a decorative staple, a push means 308 which comprises a spring and plate or any other suitable means e.g. tension rod etc., for pushing the decorative staples toward the outlet of the loading chamber 200.

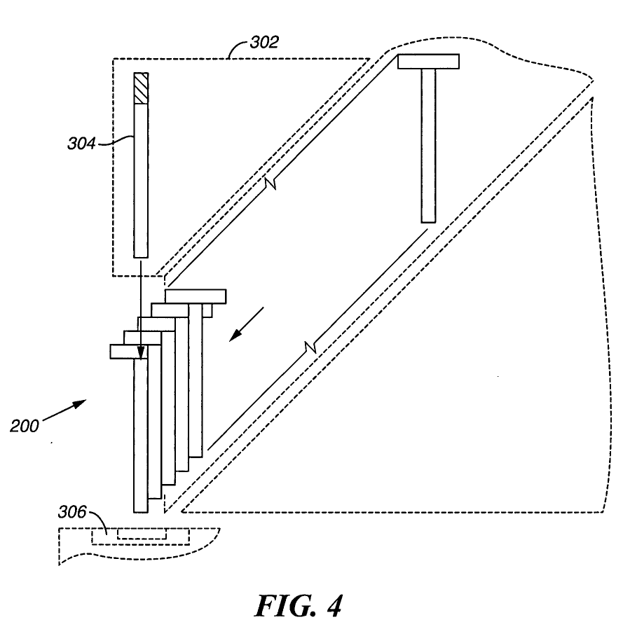

FIG. 4 shows the cut away of the loading chamber 200 in which individual decorative staples may be discharged and used. A unique feature of the apparatus is the arrangement of the decorative staples in a diagonal manner. This allows for individual decorative staples having an ornamental surface the ability to have sufficient clearance to be discharged from the apparatus. When discharge plate 304 contacts a decorative staple, it is individually removed from its' stored plurality and fastened to the desired surface. The staples in the ‘pack’ would be glued or attached to each other in the standard manner (or in any way deemed appropriate by those skilled in the art).

The Loading chamber has its front cut out entirely except for the sides (which hold in the staple) so that the front portion of the ornamental surface can advance past the end of the chamber, this allows for the plunger to hit the prongs/legs and push the staple down without interference. This front section may be covered by an outer cover etc.]

Additionally, the bottom of the loading chamber has a gap (that may run the length of the magazine) in the middle (under the design) so that when the first staple is pushed into the paper, the decorative top is able to reach the paper without obstruction. Preferrably, there is be some bottom area running the length of the sides of the magazine leaving only the legs of the first staple ‘hanging’ over the paper.

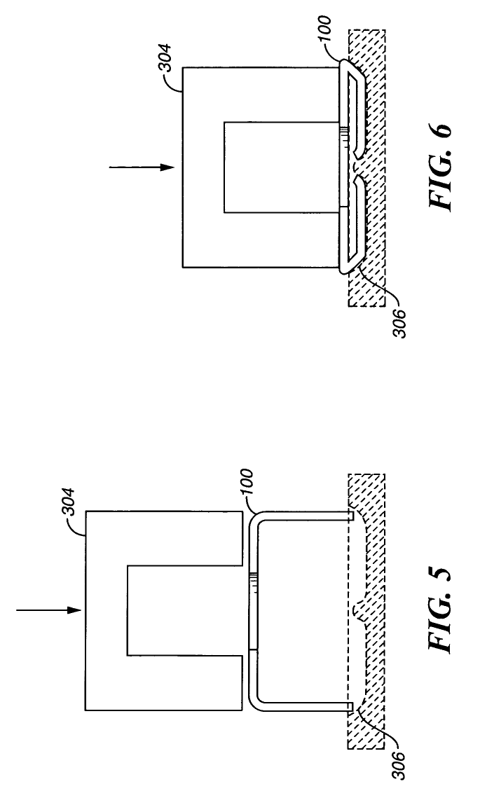

FIGS. 5 and 6 illustrates how the decorative staple is fastened without damaging the image on the ornamental surface. The discharge plate 304 is formed such that two vertical members contact the staple on either side of the ornamental surface without contacting said ornamental surface. FIG. 6 illustrates the final step of the fastening process such that no contact is made with the ornamental surface. In performing the fastening in this manner, the user is assured of not damaging the ornamental surface. Discharge plate 304 forces the staple into closing plate 306. The closing plate is the same as a conventional stapler. It directs the two vertical members of the decorative staple into a conventional position for securing the decorative staple to a desired surface. In a preferred embodiment the discharge plate is split into at least two portions. A primary purpose of the split discharge plate is so that it may push the first staple into the paper but not hit the next staple in the pack which may overlap significantly over the design on the first staple that is being discharged

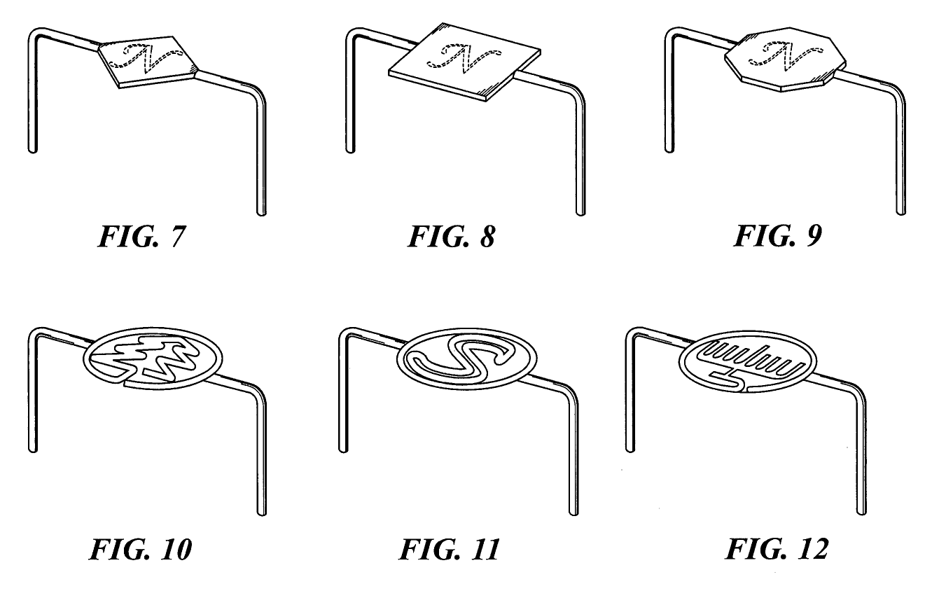

FIGS. 7-12 are illustrative of various embodiments and are in no means intended to be limiting.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

1. An apparatus for securing decorative staples comprising:
a. a loading chamber for holding said decorative staples
b. a means for discharging said decorative staples from said loading chamber
c. a means for securing said decorative staples to a desired surface.

2. The apparatus of claim 1 wherein said loading chamber holds a plurality of said decorative staples.

3. The apparatus of claim 1 wherein said loading chamber is formed with at a suitable angle for holding said plurality of decorative staples in a manner that facilitates their individual discharge.

4. The apparatus of claim 1 wherein said loading chamber is detachably or hingedly removed from the apparatus so as to facilitate loading of said decorative staples.

5. The apparatus of claim 1 wherein said loading chamber is in direct contact with a push means for providing sufficient force so as to align said decorative staples over an exit from said loading chamber.

6. The apparatus of claim 5 wherein said push means is a spring and a solid plate

7. The apparatus of claim 1 wherein said loading chamber discharges individual decorative staples when activated by the user.

8. The apparatus of claim 7 wherein said discharge of individual decorative staples occurs by activation of a discharge plate.

9. The apparatus of claim 8 wherein said discharge plate does not contact the ornamental surface of said decorative staple.

10. The apparatus of claim 9 wherein said discharge plate forces the decorative staple through the desired surface and onto a closing plate.

11. The apparatus of claim 10 wherein said closing plate secures said decorative staple to a desired surface.

12. A decorative staple comprising:
a. two parallel vertical members
b. a horizontal member
c. an ornamental surface secured to the horizontal member.

13. The decorative staple of claim 11 wherein said ornamental surface contains a design, logo, picture, monogram, name or advertising.

14. The staple of claim 11 wherein said ornamental surface is created by printing indicia, engraving, embossing, etching, or twisting of wire.

15. The staple of claim 11 wherein said ornamental surface is visible on the outer surface when the staple is secured to a surface.

16. The staple of claim 11 wherein said ornamental surface extends along the surface in which the staple is secured in a substantially planer manner.
